(19) United States
(12) Patent Application Publication
(10) Pub. No.: US 2015/0082883 A1
(43) Pub. Date: Mar. 26, 2015

(54) Hail Event Recorders

(71) Applicant: Thomas R.C. Moffatt, Cobourg (CA)

(72) Inventor: Thomas R.C. Moffatt, Cobourg (CA)

(21) Appl. No.: 13/998,035

(22) Filed: Sep. 25, 2013

(51) Int. Cl. G01N 17/00

(52) U.S. Cl. CPC G01N 17/00
USPC 73/431

(57) ABSTRACT

Hail event recorders are provided which are useful in assessing the occurrence and severity of hail on roofing components, including shingles. An article as provided herein is in some embodiments attached to a roof, and a subsequent hail storm causes a physical change in a recording panel surface present on the hail damage recorder. Providing a plurality of standardized test swatches created under laboratory conditions of varying bombardments of different-sized hail and at different velocities and angles of attack enables comparison of a deformed recording panel surface to the laboratory-created test swatches, enabling verification of the occurrence of a hail event, and its severity.

### TECHNICAL FIELD

This invention relates generally to event detection. More particularly, it relates to determination of whether or not a weather-related event has occurred.

### BACKGROUND OF THE INVENTION

The statements in this background section merely provide background information related to the present disclosure and may not constitute prior art.

Weather-related damage to structures including motor vehicles, private dwellings, commercial real estate, and roofs on buildings is always associated with some financial loss. Insurance industry analysts therefore might be expected to have a strong interest in collecting as much pertinent information relating to damage claims as possible, to effectively manage finances.

One specific type of weather-related damage is hail damage inflicted on to roof structures, golf courses, gardens, and the like. Hailstorms occur irregularly but frequently and in the cases of large hail, significant damage amounting on the order of several billions of dollars annually. A single hailstorm in Denver on Jul. 11, 1990 was estimated to have caused over one billion dollars in damages itself.

According to the Rocky Mountain Insurance Information Association, one aspect of current methods of determining damage to a roof structure from a hailstorm includes observing whether or not local foliage, such as trees, shrubberies, and other plants around a house is stripped of leaves or otherwise apparently damaged. Another aspect of current methods for determining whether hail damage to a roof has occurred is observing the condition of patio covers, screens, and roof vents, when present. Dents in automobiles and broken glass are also observables useful in determining whether hail damage has occurred in the immediate area. However, relying on the condition of local foliage to indicate potential damage to say, roofs on private dwellings and other structures is problematic in that no standard exists, i.e., it has not been determined nor universally agreed as to which foliage is the best indicator, and the fact that the nature and amount of foliage in various different geographical locations is highly diverse. Attempting to correlate damage to roof structures based on observed damage to glass and motor vehicles in a vicinity of a recent hailstorm is largely unpredictable, owing to diversity in angles of attack, materials of construction, and the size of the hail. One further complicating factor is that hailstorms often result in erratic dispersion of hail of size sufficient to cause damage, i.e., hail damage can occur to one house or building and not an adjacent one. Similarly, one area of a roofing structure might suffer hail damage whereas a different area on the same roof is unscathed.

The ability to record a hail event is very important particularly in the case of buildings having asphalt shingles. Asphalt shingles that sustain hail damage of any degree can have their life cycle reduced dramatically. Typically, new samples of asphalt shingles are tested and rated for resistance to hail damage. Aged samples are not tested and an aged asphalt shingle is more susceptible to damage than a new shingle. Typically a building or home owner has up to 12 months to make an insurance claim for hail damages, but asphalt shingles struck by hail may not show evidence of damage for some time even after years following the occurrence of the hail damage. Without an indicator of damage, there is currently no way to back up a claim that hail damage has occurred. Even small-sized hail can damage an aged roof by loosening the granular surface of asphalt shingles, exposing the underlying asphalt to degradation by UV light, consequently shortening the service life of the roof. Manufacturers of asphalt shingles offer consumers the option of shingles with a lifetime warranty and it is accordingly in the interest of both the manufacturer and consumer to accurately determine the occurrence and severity of a hail event.

At present there is no calibrated instrument, article, or method that is widely accepted as the standard by insurance or other analysts or industries for making assessments of the occurrence and extent of hail damage to roofs or other structures or articles of manufacture. The ability to more accurately determine hail damage than permitted currently-known methods and devices would be a benefit to the roofing industry, as well as property owners including owners of real property, and insurance companies.

### SUMMARY OF THE INVENTION

Hail event recorders are provided that are useful for determining the occurrence and severity of hail damage, comprising: a) a substantially planar base portion having a length dimension, a width dimension, and a thickness to which is removably-attached a recording panel surface having a length dimension, a width dimension and a thickness. A gap exists between the recording panel surface and the base portion, and there is provision for attaching the recorder to the surface of a roof. The recording panel surfaces are calibrated recording panel surfaces.

Also provided are methods for determining the occurrence and severity of a hail storm on components of a roof structure, comprising: providing a calibrated hail event recorder as described above and elsewhere in this specification, installing the recorder on a roof structure, experiencing a time delay between the installation and a time when a hail storm drops hail onto the roof structure, and making an observation of the condition of the recording panel surface against a spectrum of standardized test swatches. A conclusion is subsequently drawn concerning the occurrence and severity of the hail storm on the roof components.

### BRIEF DESCRIPTION OF THE DRAWINGS

The drawings shown and described herein are provided for illustration purposes only and are merely exemplary of different embodiments provided herein, not intended to be construed in any delimitive fashion.

FIG. 1 is a perspective view of an article useful in assessing hail damage in accordance with some embodiments of the disclosure;

FIG. 2 is a side view of an article useful in assessing hail damage in accordance with some embodiments of the disclosure;

FIG. 3 is a side view of an article useful in assessing hail damage in accordance with some embodiments of the disclosure;

FIG. 4 is an end view of an article useful in assessing hail damage in accordance with some embodiments of the disclosure.

### DETAILED DESCRIPTION

The following description is exemplary in nature, and is not way intended to limit the present disclosure, application, or uses.

The present disclosure provides a dedicated device for recording the incidence of, and assessing the severity of, a hail event as it relates to a structure or building.

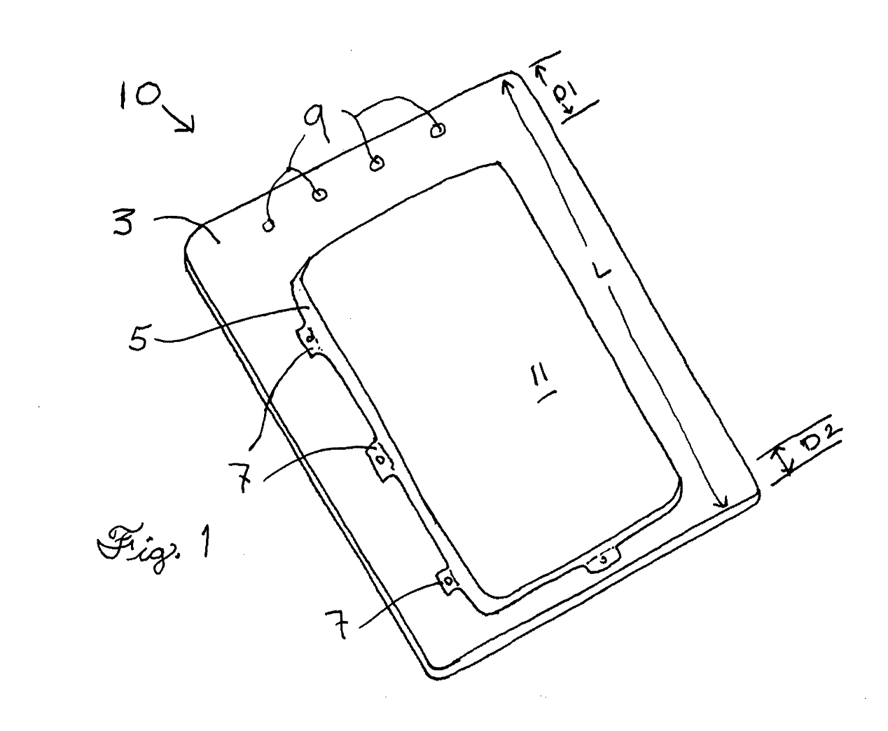

Referring now to the drawings, and initially to FIG. 1, there is shown a perspective view of a diagnostic tool article according to some of the embodiments of this disclosure, which is a hail event recorder 10. Such articles includes a base portion 3 which in some embodiments is made from a metallic substance, including metals and metallic alloys or mixtures thereof, which optionally contain non-metallic elements as part of their composition and are not appreciably deteriorated by corrosion or other weather effects over time at a rate greater than articles generally recognized as useful in outdoor environments for at least five or at least ten years and in some instances such as when aluminum is employed, at least 20 years. Suitable materials include without limitation aluminum and its alloys, stainless steel, galvanized steel. In other embodiments such base portion 3 is comprised of non-metallic materials including sheets of polymeric materials, and composite materials. Within the description of polymeric materials are included both known thermoset and thermoplastic resins, which include without limitation polyolefins, urethanes and alloys of any one or more than one of any material within any of the foregoing classifications with others among the same or different classification. In some embodiments, base portion 3 is planar and exists in the form of a rectangle. In other embodiments base portion 3 can be of any polygonal shape selected, also including ovoid and circular geometries. In rectangular base embodiments, base portion 3 has a length dimension L and a width dimension W. In some embodiments base portion 3 includes a plurality of holes 9 that are useful when affixing a hail event recorder 10 to a building structure using conventional fasteners such as screws or nails. Although shown having four holes 9, the present disclosure includes any number of holes 9 disposed at any selected location on base portion 3 as a provision for attaching a hail event recorder 10 to a roof surface.

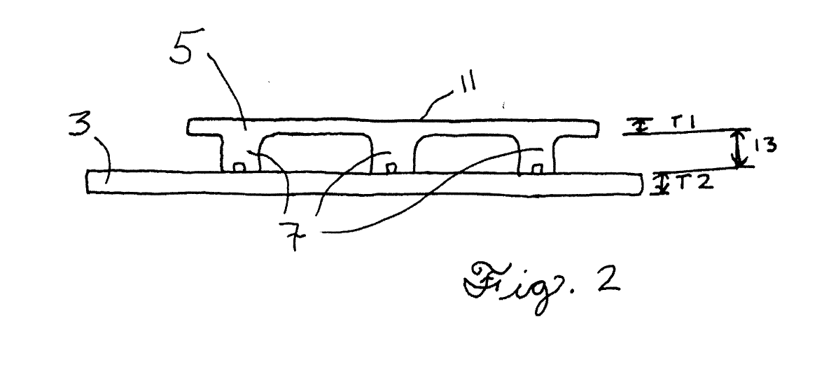

A recording panel surface 11 is attached to base portion 3 via supports 7 which maintain recording panel surface 11 above the surface of base portion 3 to create a space or gap 13 (FIG. 2) between the recording panel base 5 and/or recording panel surface 11 and base portion 3 that permits uninhibited deformation of recording panel surface under the influence of bombardment by hail. In some embodiments supports 7 are a part of recording panel base 5 and comprise legs and are attached to base portion 3 using conventional fasteners which can be selected from nuts and bolts, rivets, welds, and screws, and integral constructs containing these elements in a singular article, such as by stamping. Rivets tend to be somewhat permanent and in some embodiments it is selected that the fastener employed to affix recording panel surface 11 to base portion 3 are of any type that enables recording panel surface 11 to be readily removed and replaced with a fresh recording panel surface 11, such as after a hailstorm. Such feature enables convenient removal of a spent recording panel surface and its replacement with a fresh recording panel surface, and remote or in-field evaluation of recording panel surface 11 against a spectrum or array of standards. Supports 7 in some embodiments are provided when recording panel base 5 is made by stamping or die-cutting the material from which it is constructed in planar form and then subsequently bending the portions which are to be the supports 7 an appropriate amount to serve their function. Thus in some embodiments supports 7 are tangs that are optionally provided with holes in them to receive a fastener to hold the recording panel base 5 to base portion 3. In some alternate embodiments, supports 7 do not comprise a hole for receiving a fastener, but rather the base portion 3 includes slots appropriately spaced which are configured to receive the supports acting as tangs that are manually inserted into the slots, a slight amount of bending being required for the insertion, after which recording panel base 5 is maintained in position relative to base portion 3 by mechanical bias of such supports 7 acting as tangs.

In some embodiments, recording panel surface 11 and recording panel base 5 are one and the same, surface 11 being the outer surface of recording panel base 5, such as when recording panel base 5 is selected to comprise sheet aluminum of a pre-selected thickness, for then the recording panel surface 11 is the surface of the aluminum employed. In other embodiments, the recording panel surface 11 is of a different composition of material than is the recording panel base 5, such as embodiments in which recording panel base 5 is comprised of sheet aluminum of a selected thickness, and recording panel surface 11 is a material other than sheet aluminum, the use of aluminum in the foregoing being merely exemplary. These elements or features are selected to provide a recording panel surface 11 that deforms in a predictable and consistently-reproducible manner under the influence of a hailstorm from one recording panel surface 11 to the next, intended for deployment according to this disclosure.

In some embodiments recording panel surface 11 is a layer of material different in composition from recording panel base 5 and in other embodiments recording panel surface 11 is a multi-layer of material in contact with recording panel base 5. One non-limiting example of a multi-layer of material in contact with recording panel base 5 is when recording panel base 5 is made from aluminum, and the multi-layer material is a layer of asphalt disposed over the aluminum, atop of which is applied a particulate material, such as the particulate material used as the outer layer on conventional asphalt shingles. In other embodiments, a u.v. light-stabilized acrylic resin binder is employed in the stead of the asphalt in the foregoing.

In some embodiments the recording panel surface is planar and in other embodiments the recording panel surface 11 is non-planar and can optionally include different areas having different surface features, such as depressed areas, and elevated areas, as selected by engineers and users. In some embodiments recording panel surface 11 is concavely-shaped. In other embodiments recording panel surface 11 is convexly-shaped.

In some embodiments in which base portion 3 and recording panel base 5 are selected to be planar, recording panel base 5 is attached to the base portion 3 such that the angle between recording panel base 5 and the base portion 3 is about zero degrees, i.e., the recording panel base 5 and the base portion 3 are parallel to one another, and in optional embodiments, they are substantially parallel to one another. In other embodiments, recording panel base 5 is attached to the base portion 3 such that the angle at which their planes intersect is any angle in the range of between about 0 degrees and 45 degrees, including all degrees of angle and ranges of degrees of angle therebetween. This is accomplished by selecting the lengths of some of the supports 7 to be longer than others, as is appropriate for the angle desired.

Upon attachment to a structure, home, or building, for some embodiments recording panel surface 11 is planar or substantially planar, the angle between the recording panel surface and base 3 is zero degrees (parallel to recording panel surface 11) and recording panel surface 11 is oriented such that hail can strike the recording panel surface, creating an impression thereon or otherwise altering recording panel surface 11. In some embodiments, a hail event recorder 10 is affixed to a building surface such as a roof such that the recording panel surface 11 is parallel to the building surface, and can accordingly record the occurrence and severity of a hail event as it relates to the building's component, viz., a shingle roof. In some embodiments, a plurality of hail event recorders 10 are affixed to a building's outer surface, including its roof.

Following a hail event such as a hailstorm, a recording panel surface 11 having been struck by hail is subsequently observed and compared to test sample swatches. An observing person is able to then determine the closest match of the condition of recording surface 11 of hail event recorder 10 against standardized test sample swatches to conclude the degree of, and severity of the hail damage. Pertinent observations include one or more than one of the size of the hail, number of hail strikes per unit area and the orientation of the strikes (angle of attack) with respect to or caused by winds, in any combination alone or with any one or more of the others.

### Standardized Test Swatches

For some embodiments, standardized test swatches are created by first selecting a structure and composition configuration for the recording panel base 5 and recording panel surface 11 that is to be used in constructing hail event recorder 10. As mentioned, recording panel base 5 and recording panel surface 11 in some embodiments are of singular construction, such as both of these elements or features collectively comprising a single sheet of aluminum of pre-selected thickness. In other embodiments, recording panel base 5 and recording panel surface 11 can be multi-layered structures comprising 2, 3, 4, 5 or more separate layers.

Once the composition and configuration of recording panel base 5 and recording panel surface 11 have been selected, several samples of such units are made, which are then subjected under laboratory conditions to bombardments by simulated hail of an appropriate selected uniform diameter distribution of the individual hailballs at a selected velocity that closely approximates the actual speed of such-sized hail in natural environmental conditions, at varying angles of attack to the samples of such units. Toward this end the apparatus described in U.S. Pat. No. 6,769,287 to Stewart et al. is employable, however, any other contrivance suited to accomplish the above is also useful in this regard.

Once several samples of the recording panel surface have been produced and bombarded under varying conditions using various-sized hail, the samples are then arranged to form a spectrum or array of the samples, analogously to the panel of copper swatches used as the comparative standard when conducting ASTM test D-130 for copper corrosion in hydrocarbon oil-based formulations. In but one of many possible schemes according to the invention, four standardized test samples are provided: 1) impressions made with hail having an average diameter of one-half inch hail on recording panel surface 11, impressions made with hail having a one-inch average diameter thereon, impressions made with hail having an average diameter of an inch and a half thereon, and impressions made with hail having a two-inch average diameter thereon. However, standardized test swatches or samples can be generated using hail of any selected average diameter, at any selected angle of attack and velocity desired or selected by the scientist workman to yield a spectrum or array of standards useful for comparison with a recording panel surface 11 that has been exposed in the field to a hailstorm. Being permanently deformable under the influence of a hailstorm, recording panel surface 11 accordingly provides a means for recordation of the occurrence and severity of a hailstorm. The same technique used to bombard a hail event recorder 10 according to this disclosure when generating standardized test swatches can also be used on existing shingles, in a new condition, to enable comparison of degree of damage done to new shingles with the same impact on a hail event recorder 10 according to this disclosure. New shingles can thus be assigned a performance rating, and existing shingles having existing ratings can be calibrated against hail event recorders according to this invention. In such fashion is provided a recording panel surface 11 that is a calibrated recording panel surface. In some embodiments the calibrated recording panel surface 11 is calibrated against new shingles' performance under laboratory conditions of bombardment by hail so that when an actual hail event occurs on such shingle when installed, the calibrated recording panel surface 11 of hail event recorder 10 also installed in proximity to such shingle gives an accurate reading as to the effect such hail event has on such shingles. In some embodiments recording panel surface 11 can also be tested or calibrated against various other roof systems including industrial commercial types of B.U.R. tar-gravel roof systems, systems featuring ethylene propylene diene (EPDM) monomer rubber, thermoplastic olefins (TPO's) and PVC or other plastic based roof systems. In other embodiments the calibrated recording panel surface 11 is calibrated using a device as set forth in U.S. Pat. No. 6,769,287 to Stewart et al. or like machines for simulated hail events having varied angles of attack and magnitude of velocity under laboratory conditions so that when an actual hail event occurs on the calibrated recording panel surface 11 of hail event recorder 10 when installed in the field, an accurate reading as to the effect such hail event has on such recording panel surface 11 can be compared to the laboratory-generated sample or a spectrum or array of various sample swatches. In other embodiments, a calibrated recording panel surface 11 is calibrated against a spectrum or array of both affected shingles and recording panel surfaces 11 subject to laboratory conditions using a device as set forth in U.S. Pat. No. 6,769,287 to Stewart et al. or like machines.

Base portion 3 includes in some embodiments holes 9 that enable the use of screws, nails, etc. for fastening a hail event recorder 10 to a surface that is to be monitored, such as a roof. However, any other known suitable means for attachment of hail event recorder to a substrate including without limitation roofs are acceptable. Base portion 3 in some embodiments has a length dimension L and a width dimension W. The placement of recording panel base 5 with respect to base portion 3 along its length is in some embodiments such that there are two distances, D1 and D2 which can be considered. When recording panel base 5 is selected to be rectangular in geometry with its longest length dimension being parallel to L of base portion 3 to which it is attached, for some embodiments D1 is greater than D2, and D1 is sufficient to enable hail event recorder 10 to be attached to a roof so that the area in FIG. 1 that is defined as having as its width D1 and length W is covered by the free edge of an asphalt shingle that is located just above the location at which hail event recorder 10 is disposed. Such feature creates the opportunity to prevent moisture from leaking through the roof, and more effectively when roofing pitch is applied about the perimeter of such a hail event recorder 10 at the time of installation of base portion 3. Embodiments of this disclosure also comprise an optional feature on the surface of base portion 3 that faces the underside face of recording panel base 5 to assist in water drainage in the case of rainy weather. Such features can include channels within such surface of base portion 3 and also scuppers (weepers) as such are known in the art.

FIG. 2 shows a side view of a hail event recorder in accordance with some embodiments of the disclosure, depicting the respective locations of base portion 3, recording panel base 5, recording panel surface 11, and supports 7. Also depicted are T1 and T2 representing the thicknesses of base portion 3 and recording panel base and surface respectively. The thicknesses shown in FIGS. 2, 3, 4 are for illustration only and not necessarily of the same magnitude or relative proportion than for all embodiments, as T1 can be any thickness in the range of between 0.4 and 15 millimeters, including all thicknesses and ranges of thicknesses therebetween, and T2 can be independently from T1 any thickness in the range of between 0.4 and 15 millimeters, including all thicknesses and ranges of thicknesses therebetween. Gap 13 is illustrated as the distance between base portion 3 and recording panel base 5, and for embodiments in which the planes of base portion 3 and recording panel base 5 are parallel or substantially parallel to one another, gap 13 is any distance in the range of between 1 and 100 millimeters, including all distances and ranges of distances therebetween.

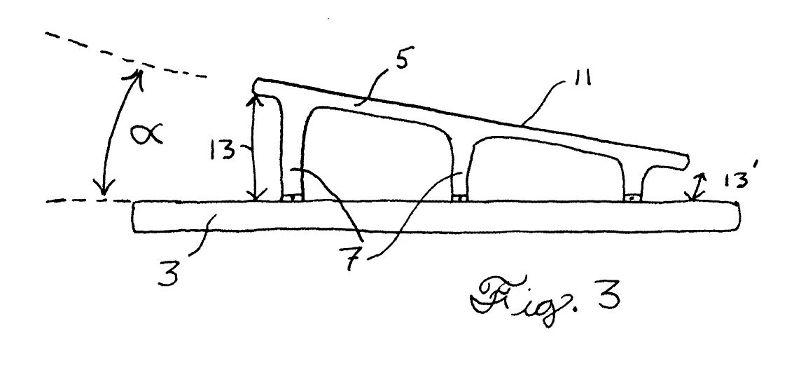

FIG. 3 is a side view of a hail event recorder in accordance with some embodiments of the disclosure, depicting the respective locations of base portion 3, recording panel base 5, recording panel surface 11, and supports 7. Also shown for the many embodiments all representatively illustrated by FIG. 3 is the angle alpha a that recording panel base 5 makes with respect to base portion 3 for embodiments in which the planes of base portion 3 and recording panel base 5 are not parallel to one another. For such embodiments, angle alpha a can have any value in the range of between zero and sixty degrees, including all degrees of angle and ranges of degrees of angles therebetween. In such embodiments it is noticed that there are two gaps, 13 and 13′, each having a different value of distance from the surface of base portion 3 at the opposite ends of recording panel base 5. The presence of angle alpha means that different portions of recording panel base 5 are disposed at different distances from base portion 3, which adds dimension to some embodiments inasmuch as the same size hail striking recording panel base 5 at the same velocity but at different locations along the length of recording panel base 5 can have differing effects on the recording panel surface 11 depending on the distance of gap 13 at impact points, owing to the backstop effect of base 3 in such embodiments. This feature adds further versatility to the invention in terms of preparation of standardized test swatches and the geometry and configuration of hail event recorders 10 deployed in the field.

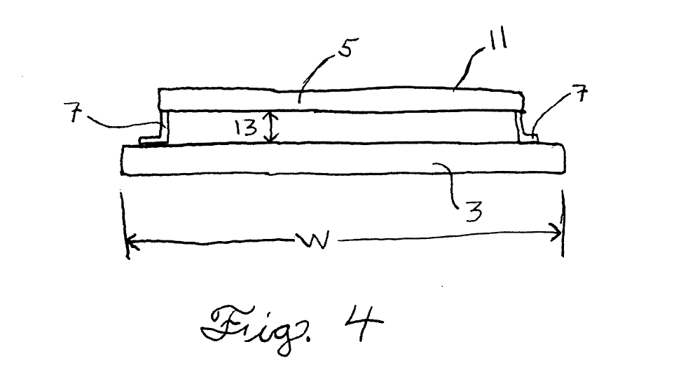

FIG. 4 is an end view of a hail event recorder in accordance with some embodiments of the disclosure, showing the respective locations of base portion 3, recording panel base 5, recording panel surface 11, gap 13, and supports 7. Width W is also depicted.

In some embodiments a hail event recorder 10 according to this disclosure is constructed from materials that are paintable, to enable them to be color-matched or blended into their surroundings. Further, recorders according to this invention are useful with all types of shingles as roof components, in addition to asphalt shingles, including wood shakes, ceramic tile shingles, adobe shingles, B.U.R. tar-gravel roof systems, systems featuring ethylene propylene diene (EPDM) monomer rubber, thermoplastic olefins (TPO's) and PVC or other plastic based roof systems. Moreover in some embodiments the recorders 10 according to the invention are each stamped with or otherwise have permanently attached to them their own individual unique serial number, which can be documented and attached to or associated with in a computer file a physical location at which such unique recorder 10 is to be deployed, including without limitation the use of GPS coordinates as location identifiers.

Consideration must be given to the fact that although this invention has been described and disclosed in relation to certain preferred embodiments, equivalent modifications and alterations thereof may become apparent to persons of ordinary skill in this art after reading and understanding the teachings of this specification, drawings, and the claims appended hereto. The present disclosure includes subject matter defined by any combinations of any one or more of the features provided in this disclosure with any one or more of any other features provided in this disclosure. These combinations include the incorporation of the features and/or limitations of any dependent claim, singly or in combination with features and/or limitations of any one or more of the other dependent claims, with features and/or limitations of any one or more of the independent claims, with the remaining dependent claims in their original text being read and applied to any independent claims so modified. These combinations also include combination of the features and/or limitations of one or more of the independent claims with features and/or limitations of another independent claims to arrive at a modified independent claim, with the remaining dependent claims in their original text or as modified per the foregoing, being read and applied to any independent claim so modified. The present invention has been disclosed and claimed with the intent to cover modifications and alterations that achieve substantially the same result as herein taught using substantially the same or similar structures, being limited only by the scope of the claims which follow.

1. A hail event recorder useful for determining the occurrence and severity of hail damage comprising:
a) a substantially planar base portion having a length dimension, a width dimension, and a thickness;
b) a recording panel surface having a length dimension, a width dimension and a thickness, and being removably-attached to said base portion in such fashion as provides a gap between said recording panel surface and said base portion; and
c) provision for attaching said recorder to the surface of a structure that is to be evaluated,
said recording panel surface being a calibrated recording panel surface.

2. A recorder according to claim 1 wherein said gap is any distance in the range of between 1 and 100 millimeters.

3. A recorder according to claim 2 wherein the thickness of said base portion is any thickness in the range of between 0.4 and 15 millimeters.

4. A recorder according to claim 3 wherein the thickness of said recording panel surface is any thickness in the range of between 0.3 and 25 millimeters.

5. A recorder according to claim 1 wherein said recording panel surface and said base portion are each substantially-planar and oriented with respect to one another such that their planes are disposed at any angle in the range of between zero degrees (parallel planes) and sixty degrees

6. A recorder according to claim 5 further comprising a recording panel base upon which said recording panel surface is present, said recording panel base being removably-attached to said base portion in such fashion as provides a gap between said recording panel base and said base portion.

7. A recorder according to claim 6 wherein said gap is any distance in the range of between 1 and 100 millimeters.

8. A recorder according to claim 7 wherein the thickness of said base portion is any thickness in the range of between 0.4 and 15 millimeters.

9. A recorder according to claim 8 wherein the thickness of said recording panel surface is any thickness in the range of between 0.3 and 25 millimeters.

10. A method for determining the occurrence and severity of a hail storm on components of a roof or other surface being monitored, comprising:
a) providing a calibrated hail event recorder according to claim 1;
b) installing said recorder on a roof structure;
c) experiencing a time delay between said installing, and a time when a hail storm drops hail onto said roof structure;
d) observing the condition of said recorder against a spectrum of standardized test swatches;
e) drawing a conclusion about the occurrence and severity of said hail storm on said components.

11. A method according to claim 10 wherein said recorder is removed from said base portion prior to having its condition observed against a spectrum of standardized test swatches.

12. A method according to claim 10 wherein said test swatches are a plurality of recording panel surfaces that have been previously subjected to varying impacts by different sizes of hail.

13. A method according to claim 12 wherein the condition of said plurality of said test swatches have been visually calibrated against a plurality of shingles, said shingles having themselves been subjected to varying impacts by different sizes of hail, sufficiently that one of the plurality of test swatches correlates with a particular level of damage to a shingle to enable an observed recording panel surface disposed on a roof structure following a hail event to be correlated with a level of damage to a shingle also present on said roof structure.
